(19) United States
(12) Patent Application Publication
(10) Pub. No.: US 2004/0252167 A1
(43) Pub. Date: Dec. 16, 2004

(54) Liquid storage unit and liquid ejecting apparatus

(76) Inventor: Hitotoshi Kimura, Nagano (JP)

Correspondence Address: Lawrence Rosenthal, Stroock & Stroock & Lavan LLP, 180 Maiden Lane, New York, NY, 10038, US

(21) Appl. No.: 10/782,467

(22) Filed: Feb. 19, 2004

(30) Foreign Application Priority Data
Feb. 19, 2003 (JP) P2003-040631
Feb. 18, 2004 (JP) P2004-041812

(51) Int. Cl. B41J 2/175

(52) U.S. Cl. 347/85

(57) ABSTRACT

The invention provides a liquid storage unit comprising: a case, a liquid storage part for storing a liquid in the case, with which a liquid part communicates; at least one gas accommodation part for accommodating a gas in the case, with which a gas port communicates, wherein the liquid in the liquid storage part is led outs through the liquid port by a pressure of a gas introduced from the gas port; an inner case provided in the case having a pair of openings on opposite side faces thereof; and a pair of flexible partitioning members sealing said pair of openings of the inner case respectively, thereby partitioning the liquid storage part therebetween and defining said at least one of the gas accommodation part in cooperation with the case.

The present application is based on Japanese Patent Application No. 2003-40631; the entire contents of which are incorporated herein by reference.

### BACKGROUND OF THE INVENTION

1. Field of the Invention

The present invention relates to liquid storage unit and a liquid ejecting apparatus mounting the liquid storage unit thereon.

2. Related Art

Conventionally, a liquid ejecting apparatus for injecting a droplet from the nozzle of a liquid ejection head includes an ink jet printer. Some ink jet printers include an ink supply system of an off carriage type for mounting an ink cartage in a place other than a carriage. The case in which the ink supply system of the off carriage type is provided includes the case in which an ink cartridge having a large capacity is provided for large printing and the case in which the ink cartridge is not mounted but the size of a carriage is reduced and the size and thickness of the ink jet printer is decreased.

In the ink supply system of the off carriage type, for example, the ink cartridge is provided on a body side. An ink is supplied from the ink cartridge to a subtank mounted on the carriage through a supply tube. On the other hand, there is a problem in that the dynamic pressure of the ink in the supply tube is raised because of an increase in the flow of the ink due to an increase in the speed and fineness of the printing of a printer, resulting in the insufficiency of the amount of the ink supplied to the subtank.

In order to solve the problem, there has been proposed an ink cartridge for accommodating a bag-shaped ink pack in the case of the ink cartridge and introducing air between the case and the ink pack, thereby pressurizing the ink pack to forcibly lead out an ink (for example, see JP-A-2001-212973).

In the ink cartridge for accommodating the bag-shaped ink pack in the case, however, it is necessary to raise an air pressure between the case and the ink pack. For this reason, the opening portion of the case for attaching the ink pack is to be sealed in an airtight state as shown in FIG. 10. In an ink cartridge 51, a plug member 55 sealing the opening portion of an ink pack 54 is protruded from an opening portion 53 formed on a case 52 toward an outside. In this state, an O-ring 56 is attached to the opening portion 53, and furthermore, an engaging member 57 is pushed in from the outside of the case 52. Consequently, the plug member 55 is fixed to the opening portion 53 in the airtight state.

In the ink cartridge for accommodating the bag-shaped ink pack in the case, accordingly, a seal member for enhancing a sealing property is required and the structure of the seal member is complicated. Accordingly a cost is increased or the size of an apparatus is increased in some cases.

To cope with the above problems, there have been proposed an ink cartridge (for example, JP S59-209878A) in which a bag member provided with a flexible film covers a recessed face of the cartridge body so that an ink is filled in a space formed between the bag member and the recessed face. A rigid lid having recess corresponding to the bag member filled with the ink is attached on the cartridge body. The bag member is pressurized by providing air between the bag member and the lid so that the ink is led out from the cartridge.

Since any ink pack is not housed, no sealing member for ink pack is provided in the cartridge. Therefore, such the ink cartridge can be provided with a simple structure in small size at low cost.

Meanwhile, even in the cartridge as disclosed in JP S59-209878A, it is important to keep sufficient deaeration degree of the ink for maintaining the quality of ink. However, in the ink cartridge of JP S59-209878A, the space in which the ink is filled is formed by the flexible film on one side face and the rigid main body on the other side faces. The main body of the cartridge is usually made of a plastic resin with a low gas barrier property. Therefore, even if only one side face is covered with the film with high gas barrier property, the total degree of deaeration of the ink filled in the space does not reach sufficiently high since a large portion of the surface of the space is defined by the main body

Further, in JP S59-209878A, a space into which air is introduced is formed by fixing the rigid lid onto the rigid cartridge body. Accordingly, for fixing the lid onto the main body, it is necessary to use a simple manufacturing device and to avoid generation of foreign substances by operation as much as possible.

The invention relates to a liquid storage unit which is available by a simple manufacturing device, avoiding generation of foreign substances, and a liquid ejection apparatus in which the liquid storage unit is mounted.

### SUMMARY OF THE INVENTION

The invention provides a liquid storage unit comprising:

a case;

a liquid storage part for storing a liquid in the case, with which a liquid port communicates;

at least one gas accommodation part for accommodating a gas in the case, with which a gas port communicates, wherein the liquid in the liquid storage part is led out through the liquid port by a pressure of a gas introduced from the gas port;

an inner case provided in the case having a pair of openings on opposite side faces thereof; and

a pair of flexible partitioning members sealing said pair of openings of the inner case respectively, thereby partitioning the liquid storage part therebetween and defining said at least one of the gas accommodation part in cooperation with the case.

According to the liquid storage unit of the invention, the air accommodation part can be formed only by partitioning the inside of the case with a partitioning member. Among the faces with which the ink storage part is defined, two side faces are provided with the flexible partitioning members, and the other faces are provided with the inner case. By such the structure, the surface of the liquid storage part which is defined by the inner case made of a material with low gas barrier property can be small, whereas the surface which is defined by the partitioning members made of a material with high gas barrier property can be large for example. As a result high degree of deaeration can be obtained in the liquid storage part. Moreover, by providing two flexible partitioning members on the liquid storage part, even if the flexibility of the individual partitioning member is not so high, the total flexibility provided by both partitioning members for the liquid storage part can be high. As a result, remaining ink amount can be reduced by such the structure.

In the liquid storage unit according to the invention, the flexible partitioning member is provided with a flexible film, which is thermally welded to a welding portion at the opening of the inner case.

According to the above structure, among the faces with which the ink storage part is defined, two side faces are provided with the flexible films, and the other faces are provided with the inner case. By such the structure, the surface of the liquid storage part which is defined by the inner case made of a material with low gas barrier property can be small, whereas the surface which is defined by the flexible films made of a material with high gas barrier property can be large for example. As a result high degree of deaeration can be obtained in the liquid storage part. Moreover, by providing two flexible films on the liquid storage part, even if the flexibility of the individual film is not so high, the total flexibility provided by both films for the liquid storage part can be high. As a result, remaining ink amount can be reduced by such the structure.

In the liquid storage unit according to the invention, the flexible film has a laminate structure including at least a welding layer weldable to the welding portion arid a gas barrier layer.

According to the above structure, it is possible to provide a liquid storage part accomplishing a higher degree of deaeration. Moreover, by providing two flexible films on the liquid storage part, even if the flexibility of the individual film is not so high, the total flexibility provided by both films for the liquid storage part can be high. As a result, the remaining ink amount can be reduced by such the structure.

In the liquid storage unit according to the invention, the case in which the inner case is provided has openings at a pair of side faces thereof corresponding to the openings of the inner case, and lids are sealed on the openings of the case respectively.

According to the above structure, by closing two openings with the lids, the liquid storage part is interposed between two air accommodation parts. Even if the remaining liquid in the liquid storage part becomes small, both of the flexible films can be flexed by introducing the air into both air accommodation parts. Therefore, even in a case that the remaining liquid in the liquid storage part is small, the liquid can be pressurized and ejected by flexion of both films.

The invention also provides a liquid storage unit comprising:

a case having an opening on a side face thereof;

a liquid storage part for storing a liquid in the case, with which a liquid port communicates;

at least one gas accommodation part for accommodating a gas in the case, with which a gas port communicates, wherein the liquid in the liquid storage part is led out through the liquid port by a pressure of a gas introduced from the gas port;

a first flexible partitioning member thermally welded to the case so as to define the liquid storage part in cooperation with the case;

a second flexible partitioning member sealing the opening of the case by thermal welding so as to define said at least one gas accommodation part in cooperation with the first partitioning member and the case.

According to the invention, by thermally welding the flexible film on to the opening of the case, few foreign substances are generated in thermal welding. Therefore, adherence of the foreign substance is not occurred. Moreover, the thermal welding can be performed easily compared to other welding methods. Therefore, the liquid storage unit having large capacity can be manufactured in an easy and simple manner.

In the liquid storage unit according to the invention, a protecting lid covering the second flexible partitioning member sealing the opening is provided in the case.

According to the above structure, the protecting lid covers the opening of the case. Therefore, breakage of the partitioning member can be prevented. Further, the portioning member forming the gas accommodation part by sealing the case also serves as a lid of the case. Therefore, it is not necessary to hermetically seal the protecting lid to the case, so that selection of material for the protecting lid is not restricted. Accordingly, the material for the protecting lid can be freely selected in a suitable manner in a case that importance is placed on the appearance of the cartridge.

The invention is also directed to a liquid ejecting apparatus comprising a liquid ejection head for discharging a liquid supplied from the liquid storage unit according to the invention, and a carriage for being reciprocated with the liquid ejection head mounted thereon.

According to the above structure, there is provided the liquid ejecting apparatus in which can the liquid can be supplied to the liquid ejecting head even if the liquid becomes small in the liquid storage unit in which the degree of deaeration is suitably maintain. Moreover, the total cost for manufacturing the liquid ejecting apparatus can be reduced by providing the liquid storage unit mounted in the apparatus to be a simple structure.

### BRIEF DESCRIPTION OF THE DRAWINGS

FIG. 1 is a plan view showing a printer body according to a first embodiment,

FIG. 2 is a typical view showing an ink supply system according to the first embodiment,

FIG. 3 is a plan view showing an ink cartridge according to the first embodiment,

FIG. 4 is a sectional view showing the ink cartridge taken along an IV-IV line,

FIG. 5 is a sectional view showing the main parts of the ink cartridge taken along a V-V line,

FIG. 6 is a plan view showing an ink cartridge according to a second embodiment,

FIG. 7 is a plan view showing an ink cartridge according to a third embodiment,

FIG. 8 is a sectional view showing the ink cartridge taken along a VIII-VIII line,

FIG. 9 is a sectional view showing the ink cartridge taken along an IX-IX line, and

FIG. 10 is a sectional view showing the main parts of a conventional ink cartridge.

### DETAILED DESCRIPTION OF THE PREFERRED EMBODIMENTS

(First Embodiment)

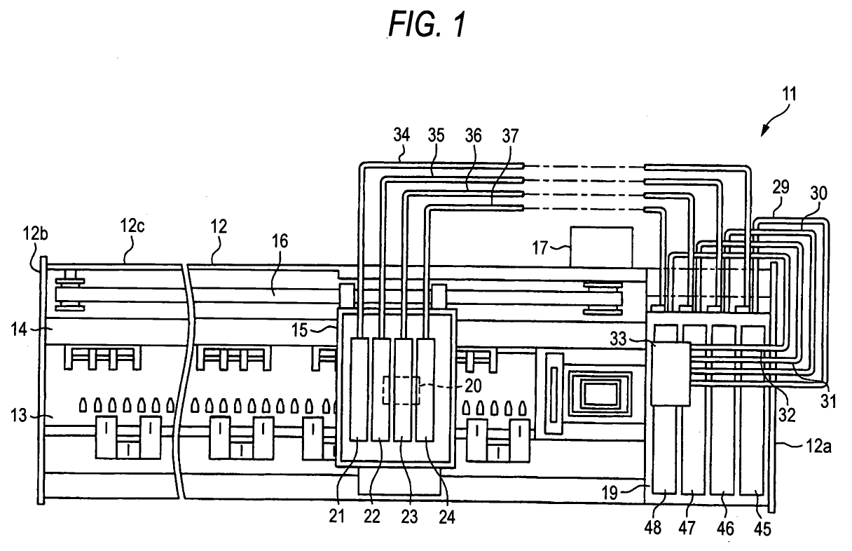

A first embodiment according to the invention will be described below with reference to FIGS. 1 to 5.

In an ink jet printer to be a liquid ejecting apparatus (which will be hereinafter referred to as a printer), a printer body 11 shown in FIG. 1 is provided in a case which is not shown. The printer body 11 comprises a frame 12 and a paper feeding member 13 provided in the frame 12. By a paper feeding mechanism which is not shown, a paper is delivered onto the paper feeding member 13. Moreover, a guide member 14 is provided in parallel with the paper feeding member 13 between a right side plate 12a and a left side plate 12b in the frame 12, and a carriage 15 is slidably supported on the guide member 14. The carriage 15 is connected to a carriage motor 17 provided on a back plate 12c of the frame 12 through a timing belt 16. The carriage 15 is reciprocated along the guide member 14 by the driving operation of the carriage motor 17.

Moreover, a recording head 20 to be a liquid ejection head is mounted on the surface of the carriage 15 which is opposed to the paper feeding member 13. Furthermore, subtanks 21 to 24 for supplying the recording head 20 with an ink to be a liquid are mounted on the carriage 15. In the embodiment, the four subtanks 21 to 24 are provided corresponding to inks for black, cyan, magenta and yellow.

A nozzle discharge port (not shown) is formed on the lower face of the recording head 20. By the driving operation of a piezoelectric unit which is not shown, the inks are discharged from respective corresponding nozzle discharge ports onto the paper so that printing is carried out.

On the other hand, the right end of the frame 12 is provided with a cartridge holder 19 for removably mounting ink cartridges 45 to 48 to be liquid storage unit. In the embodiment, the four ink cartridges 45 to 48 are provided in the cartridge holder 19 corresponding to the inks having the four colors. The ink cartridges 45 to 48 are connected to an air pump 33 through air supply tubes 29 to 32, and air to be a gas generated by the air pump 33 is supplied into the ink cartridges 45 to 48. By pressurization into the ink cartridges 45 to 48, the inks are supplied to the subtanks 21 to 24 through flexible ink supply tubes 34 to 37, respectively.

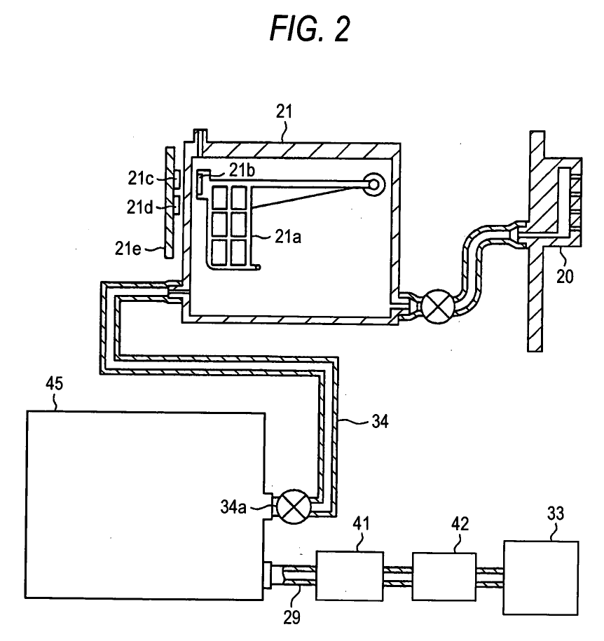

FIG. 2 is a typical view for explaining the structure of the ink supply system of the printer body 11. The ink cartridges 45 to 48, the air supply tubes 29 to 32 and the ink supply tubes 34 to 37 have the same structures, respectively. For convenience of explanation, description will be given to the ink supply system constituted by the ink cartridge 45 for supplying the ink to the subtank 21 and the description of the ink supply systems of the other ink cartridges 46 to 48 will be omitted.

The air generated by the air pump 33 is first supplied to a pressure regulating valve 42, and then, is supplied to the ink cartridge 45 through a pressure detector 41 and the air supply tube 29. The pressure regulating valve 42 has the function of releasing a pressure to set an air pressure to be applied to the ink cartridge 45 within a predetermined range when an air pressure raised by the air pump 33 reaches a predetermined value or more.

Moreover, the pressure detector 41 has the function of detecting the air pressure raised by the air pump 33, thereby controlling the driving operation of the air pump 33. More specifically, the pressure detector 41 stops the driving operation of the air pump 33 when detecting that the air pressure raised by the air pump 33 reaches a pressure having a predetermined value. The air pump 33 is controlled to be driven when, the pressure detector 41 detects that the air pressure has the predetermined value or less. Thus, the pressure detector 41 has the function of repeating the driving operation of the air pump 33 and the stop of the driving operation, thereby maintaining the air pressure to be applied to the ink cartridge 45 within a predetermined range.

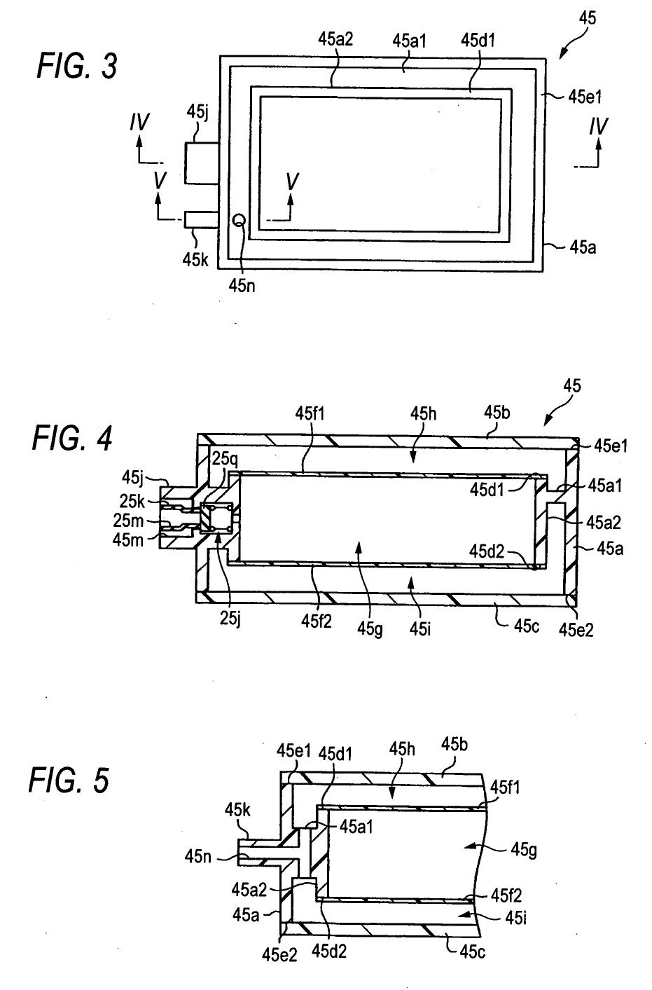

The structure of the ink cartridge 45 will be described with reference to FIGS. 3 to 5. FIG. 3 is a plan view showing a case 45a of the ink cartridge 45 seen from above.

FIGS. 4 and 5 are sectional views showing an ink cartridge 45 according to the embodiment, illustrating sections taken along IV-IV and V-V lines in FIG. 3 respectively, in which a case 45a is covered with lids 45b, 45c. The ink cartridge 45 comprises the case 45a taking the shape of a square frame in which upper and lower faces are opened. The case 45a is sealed by covering opening portions on both faces with lids 45b and 45c.

Lid welding portions 45e1, 45e2 for welding the lids 45b and 45c are formed on two faces of upper and lower faces in the case 45a formed of polypropylene or the like, respectively. An inner case 45a2 is integrally formed within the case 45a through a joint frame 45a1. The inner case 45a2 is formed with a square frame member having openings on two of the upper and lower faces on which film welding portions 45d1, 45d2 are formed respectively. Namely, the film welding portions 45d1, 45d2 are formed like square frames on the upper and lower faces. Lid welding portions 45e1, 45e2 are formed like square frames so as to surround the film welding portions 45d1, 45d2. Moreover, the lid welding portions 45e1, 45e2 are formed to be protruded from the film welding portions 45d1, 45d2. When two films 45f1, 45f2 to be flexible partitioning member are thermally welded to the film welding portions 45d1, 45d2 respectively, an ink chamber 45g to be liquid storage part is formed by the two films 45f1, 45f2 and the side faces of the inner case 45a2. Incidentally, each of the films 45f1, 45f2 is constituted by a lamination of polypropylene, a gas barrier layer and nylon or the like from a welding face side.

When the films 45f1, 45f2 are to be thermally welded to the film welding portions 45d1, 45d2, the case 45a is fixed by a fixing device (not shown) Then, a heater chip (not shown) is caused to descend from above in a state in which the films 45f1, 45f2 are mounted on the film welding portions 45d1, 45d2, and the films 45f1, 45f2 are thermally welded to the film welding portions 45d1, 45d2.

Further, the lids 45b, 45c formed by the same material as the material of the case 45a are vibrated and welded to lid welding portions 45e1, 45e2 in a state that the films 45f1, 45f2 have been welded to the film welding portions 45d1, 45d2. When the lids 45b, 45c are to be vibrated and welded to the lid welding portions 45e1, 45e2, the lids 45b, 45c abutting on the lid welding portions 45e1, 45e2 and the case 45a are interposed by two vibrating and welding devices (not shown) and a load is applied in a direction of a gravity by the driving operation of an actuator and they are driven to give a vibrating operation in a horizontal direction. By this operation, the lids 45b, 45c are slid with a load applied to the lid welding portions 45e1, 45e2. Accordingly, portions of the lids 45b, 45c which abut on the lid welding portions 45e1, 45e2 and the lid welding portions 45e1, 45e2 are molten respectively by frictional heat generated therebetween. The vibration in the horizontal direction in the vibrating and welding device is stopped while keeping the load so that the lids 45b, 45c are bonded to the lid welding portions 45e1, 45e2 in an airtight state.

As a result, a first air chamber 45h is formed above the ink chamber 45g by the lid 45b the film 45f1 and the side faces of the case 45a. By the lid 45c, the film 45f2 and the side faces of the case 45a, a second air chamber 45i is formed below the ink chamber 45g. For this reason, the inside of the case 45a is partitioned into the ink chamber 45g and the two air chambers 45h and 45i by the two films 45f1, 45f2 and the ink chamber 45g is interposed between the air chambers 45h and 45i.

Moreover, a first connecting portion 45j for connecting the ink supply tube 34 and a second connecting portion 45k for connecting the air supply tube 29 are protruded from one of the side faces of the case 45a. An ink lead-out port 45m penetrates through the first connecting portion 45j as shown in FIG. 4, and an air introducing port 45n penetrates through the second connecting portion 45k as shown in FIG. 5. The ink lead-out port 45m is formed to lead the ink stored in the ink chamber 45g to an outside, and has a valve 25j and a seal member 25k provided therein

A hole 25m for a tube penetrates through the seal member 25k. The hole 25m for a tube is constituted by a large diameter portion for fitting and inserting a supply needle (not shown) which is connected to the ink supply tube 34 and a small diameter portion. The same small diameter portion is provided to abut on a valve member 25q constituting the valve 25j. When the supply needle connected to the ink supply tube 34 is inserted into the large diameter portion in this condition, the tip of the supply needle presses the valve member 25q. The valve member 25q is separated from the small diameter portion by pressing. Therefore, the ink is introduced from the ink chamber 45g into the ink lead-out port 45m.

As shown in FIG. 5, the air introducing port 45n penetrates through the second connecting portion 45k, and furthermore, branches at the joint frame 45a1 provided on the inner faces of the case 45a in a vertical direction in the drawing, and one is opened in the air chamber 45h and the other is opened in the air chamber 45i. When the amount of the ink in the subtank 21 is decreased, therefore, the air is introduced from an air pump 33 to the first and second air chambers 45h and 45i through an air supply tube 29. As a result, a pressure in each of the air chambers 45h and 45i is raised. By the pressure, each films 45f1, 45f2 are pressed and flexed toward the ink chamber 45g. Consequently, the ink in the ink chamber 45g is led out off the ink lead-out port 45m. Also in the case in which the amount of the residual ink is small, therefore, the ink can be led out.

The ink cartridge 45 having such a structure is provided in the printer body 11 in such a manner that the lids 45b, 45c are almost parallel with the right side plate 12a and the left side plate 12b in the frame 12 as shown in FIG. 1. The ink led out of the ink cartridge 45 is introduced into the subtank 21 through the ink supply tube 34 as shown in FIG. 2. The ink supply tube 34 has an ink supply valve 34a provided in the middle thereof. The ink supply valve 34a is opened or closed so that the supply of the ink to the subtank 21 is controlled.

The subtank 21 has a float member 21a provided therein, and a permanent magnet 21b is attached to one of the ends of the float member 21a. Magnetoelectric converting units 21c and 21d formed by Hall elements or the like attached to a substrate 21e and is provided on the side wall of the subtank 21. By this structure, an electrical output is generated by the magnetoelectric converting units 21c and 21d corresponding to the amount of a line of magnetic force obtained by the permanent magnet 21b which is changed depending on the floating position of the float member 21a. For example, in the case in which the amount of the ink in the subtank 21 is decreased, the position of the float member 21a is moved downward in the direction of a gravity so that the position of the permanent magnet 21b is also moved downward. For this reason, the electrical outputs of the magnetoelectric converting units 21c and 21d can be sensed as the amount of the ink in the subtank 21. If it is sensed that the amount of the ink is small, the ink supply valve 34a is opened.

Consequently, the ink pressurized in the ink cartridge 45 is led to the subtank 21 in which the amount of the ink is reduced. In the case in which the amount of the ink in the subtank 21 reaches a predetermined capacity, the ink supply valve 34a is closed based on the electrical outputs of the magnetoelectric converting units 21c and 21d. By the repetition of the opening and closing operations of the ink supply valve 34a, the ink is supplied into the subtank 21 and the almost constant ink is always stored in the subtank 21.

According to the first embodiment, the following advantages can be obtained.

(1) In the first embodiment, the inner case 45a2 of the case 45a covered with the lids 45b, 45c is partitioned by the films 45f1, 45f2, thereby forming the ink chamber 45g and the first and second air chambers 45h, 45i. Therefore, it is not necessary to constitute the ink chamber 45g by the bag-shaped ink pack. Accordingly, the ink chamber 45g can simply be constituted and a cost in the manufacture and assembly of the ink cartridge 45 can be reduced.

Moreover, the air introducing port 45n and the ink lead-out port 45m are directly formed on the case 45a. Consequently, the air can be directly introduced from the ink introducing port 45n into the first and second air chambers 45h, 45i and the ink in the ink chamber 45g can be directly led out of the ink lead-out port 45m formed on the case 45a. Accordingly, it is not necessary to connect the case 45a to the first and second air chambers 45h, 45i and ink chamber 45g. The seal member for connection is not required. For this reason, the ink cartridge 45 can have a simple structure. Therefore, it is possible to prevent an increase in a cost and an increase in the size of the apparatus.

(2) In the first embodiment, the case 45a is partitioned by the films 45f1, 45f2, thereby forming the ink chamber 45g and the first and second air chambers 45h, 45i. The air generated by the air pump 33 is introduced into the first and second air chambers 45h, 45i. Accordingly, the flexible films 45f1, 45f2 are flexed by the pressurized air so that the ink in the ink chamber 45g can be pressurized. Also in the case in which the amount of the ink in the ink chamber 45g is small, therefore, the ink can be led out.

(3) In the first embodiment, among six side faces forming the ink chamber 45g, the upper and lower side faces which have large surface area are formed with the film 45f1, 45f2, and the other four side faces are formed with the case 45a (more specifically, the inner case 45a2). That is, the area forming the ink chamber 45g with the case 45a (inner case 45a2) made of plastic resin with low gas barrier property is lowered as much as possible, so that the area forming the ink chamber 45g with the films 45f1, 45f2 with high gas barrier property becomes large. Therefore, the ink chamber 45g with high degree of deaeration is formed.

In particular, in the embodiment, each of the films 45f1, 45f2 is constituted by laminating polypropylene, gas barrier layer, nylon and the like. The outer layer is made of polypropylene as a material weldable to the film welding portions 45d1, 45d2. The high gas barrier property can be secured by using films containing a layer of metal such as aluminum which yields good performance as the gas barrier layer. Nylon is formed on the gas barrier layer for protection.

(4) In the first embodiment, the inside of the case 45a is partitioned into the ink chamber 45g and the first and air chambers 45h and 45i by the two films 45f1, 45f2, and the ink chamber 45g is interposed between the two air chambers 45h and 45i. Also in the case in which the amount of the ink in the ink chamber 45g is decreased, therefore, the air can be introduced into each of the air chambers 45h and 45i to flex each film 45f1, 45f2. Also in the case in which the amount of the ink in the ink chamber 45g is small, accordingly, it is possible to flex the films 45f1, 45f2, thereby pressurizing the ink in the ink chamber 45g to lead out the ink. Particularly, in a case that films 45f1, 45f2 with high gas barrier property, which are generally less flexible than other films for the partitioning member, are used, the total flex amount of the ink chamber 45g can be obtained sufficiently large by providing the films on both of upper and lower face, thereby reducing the residual ink. Therefore, the remaining ink which is not utilized can be reduced while keeping degree of deaeration.

(5) In the first embodiment, each film 45f1, 45f2 is thermally welded to each film welding portion 45d1, 45d2, and the lids 45b and 45c are vibrated and welded to the lid welding portions 45e1, 45e2 protruded from the film welding portions 45d1, 45d2. For this reason, the sealing properties of the ink chamber 45g and each of the air chambers 45h and 45i can be enhanced, and furthermore, the air chambers 45h and 45i can be provided on both sides of the ink chamber 45g with a simple structure.

(6) In the first embodiment, the first connecting portion 45j and the second connecting portion 45k are formed on one of the side faces of the case 45a, and the ink lead-out port 45m and the air introducing port 45n penetrate, respectively. Therefore, it is also possible to cope with the case in which the ink is led out or the air is introduced from the side face of the ink cartridge 45 provided in the printer body 11.

(Second Embodiment)

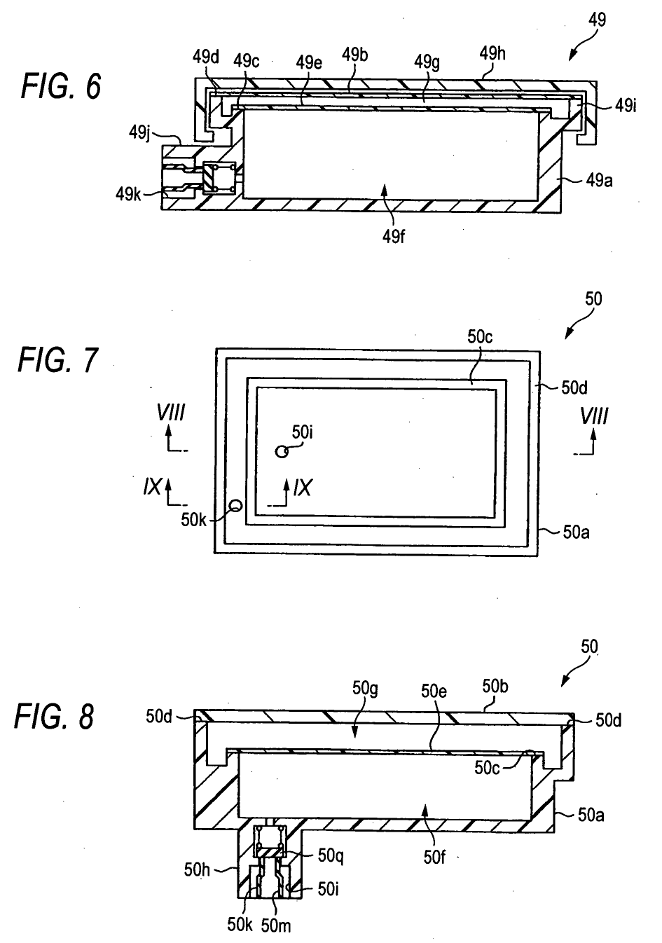

Next, a second embodiment according to the invention will be described with reference to FIG. 6. In the second embodiment, the structure of the ink cartridge according to the first embodiment is only changed. Therefore, the detailed description of the same portions will be omitted.

FIG. 6 is a sectional view showing an ink cartridge 49 taken along an IV-IV line in FIG. 3, illustrating the case in which covering with an outer film 49b and a protecting lid 49h is carried out. The ink cartridge 49 includes a case 49a taking the shape of a rectangular parallelepiped in which an upper face is opened.

A film welding portion 49c and a lid welding portion 49d are protruded from the case 49a formed of polypropylene. The welding portion 49c is formed like a square frame, and the lid welding portion 49d is formed like a square frame in order to surround the film welding portion 49c. Furthermore, the lid welding portion 49d is formed to be higher than the film welding portion 49c.

When an inner film 49e is thermally welded to the film welding portion 49c, an ink chamber 49f to be an ink storage part is formed by the inner film 49e and the bottom and side faces of the case 49a. When an outer film 49b to be a lid member is thermally welded to the lid welding portion 49d in a state in which the inner film 49e is welded to the film welding portion 49c, furthermore, an air chamber 49g is formed above the ink chamber 49f by the outer film 49b, the inner film 49e and the side face of the case 49a. Accordingly, the ink chamber 49f and the air chamber 49g are formed by thermally welding the inner film 49e and the outer film 49b in the same manner. Consequently, a step of assembling the ink cartridge 49 can be prevented from being complicated.

After the outer film 49b is welded to the lid welding portion 49d, the upper face of the case 49a is covered with the protecting lid 49h. The protecting lid 49h is formed by a synthetic resin and has a bottom, and is formed in such a manner that the end of a side face is bent inward. The bent end can be sealed with a protruded portion 49i protruded horizontally from the case 49a under the lid welding portion 49d. For this reason, the protecting lid 49h can be prevented from slipping from the case 49a.

According to the second embodiment, it is possible to obtain the following advantages in addition to the same advantages as those of the (1), (2) and (6) described in the first embodiment.

(7) In the second embodiment, the outer film 49b is thermally welded to the lid welding portion 49d in a state in which the inner film 49e is welded to the film welding portion 49c. Accordingly, the ink chamber 49f and the air chamber 49g are formed by thermally welding the inner film 49e and the outer film 49b in the same manner. Therefore, a step of assembling the ink cartridge 49 can be prevented from being complicated.

(8) Further, in the second embodiment, the thermal welding does not yield any chips as in vibration welding and there is no fear that foreign substances are adhered on the welding portions. Moreover, the thermal welding to the welding portions of the case 49a having large openings is relatively easy as compared to the vibration welding. Therefore, the ink cartridge 49 having large capacity can be manufactured in an easy and simple manner.

(9) In the second embodiment, the outer film 49b is welded to the lid welding portion 49d and the upper face of the case 49a is then covered with the protecting lid 49h. Consequently, the outer film 49b can be prevented from being broken.

In the second embodiment, the film 49b also serves as a lid of the case 49a by sealing the case 49a to form the air chamber 49g. Therefore, there is no need to weld the protecting lid 49h to the case 49a by vibration welding or the like, and selection of material for the protecting lid 49h is not restricted. Accordingly, the material for the protecting lid 49h can be freely selected in a suitable manner in a case that importance is placed on the appearance of the ink cartridge 49.

(Third Embodiment)

Next, a third embodiment according to the invention will be described with reference to FIGS 7 to 9. The third embodiment is directed to a connecting portion of the cartridge. Therefore, the detailed description of the same portions will be omitted.

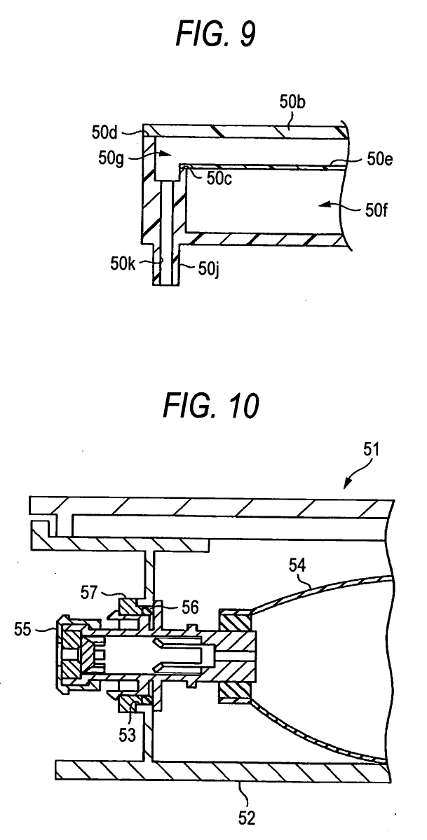

FIG. 7 is a plan view showing an ink cartridge 50 according to the embodiment as seen from above. FIG. 8 is a sectional view showing the ink cartridge 50 taken along a VIII-VIII line in FIG. 7, and FIG. 9 is a sectional view showing the ink cartridge 50 taken along an IX-IX line in FIG. 7. FIGS. 8 and 9 show the case in which a case 50a is covered with a lid 50b. The ink cartridge 50 includes a case 50a taking the shape of a rectangular parallelepiped which has an upper face opened, and the case 50a is sealed by covering the opening portion with the lid 50b.

A film welding portion 50c and a lid welding portion 50d are protruded from the case 50a formed of polypropylene. The film welding portion 50c is formed like a square frame, and the lid welding portion 50d is formed like a square frame in order to surround the film welding portion 50c. Furthermore, the lid welding portion 50d is formed to be higher than the film welding portion 50c.

On the other hand, when a film 50e is thermally welded to the film welding portion 50c, an ink chamber 50f is formed by the film 50e and the bottom and side faces of the case 50a. When the lid 50b formed by the same material as the material of the case 50a is vibrated and welded to the lid welding portion 50d, moreover, an air chamber 50g is formed by the lid 50b, the side face of the case 50a and the film 50e. Moreover, a first connecting portion 50h for fitting and inserting a supply needle connected to an ink supply tube 34 is protruded from the bottom face of the case 50a. An ink lead-out port 50i communicating with the ink chamber 50f penetrates through the first connecting portion 50h and the bottom face of the case 50a on which the first connecting portion 50h is formed.

Moreover, a second connecting portion 50j for connecting an air supply tube 29 is formed on the bottom face on which the first connecting portion 50h is formed. As shown in FIG. 9, an air introducing port 50k communicating with the air chamber 50g penetrates through the second connecting portion 50j and a side face on which the second connecting portion 50j is formed. The air introducing port 50k is constituted by a hole penetrating toward the air chamber 50g in a vertical direction in the drawing, and supplies the pressurized air fed from an air pump 33 to the air chamber 50g formed above the ink chamber 50f.

In the ink lead-out port 50i and the air introducing port 50k, thus, the first connecting portion 50h and the second connecting portion 50j are formed on the bottom face of the case 50a, and can be therefore opened on the bottom face of the case 50a. Consequently, it is also possible to cope with the case in which an ink or the air fed from the air pump 33 is to be led out of or introduced into the bottom face of the case 50a. Moreover, the ink cartridge 50 can be provided in such a manner that the bottom face of the case 50a is almost parallel with a right side plate 12a and a left side plate 12b in a frame 12. In addition, the bottom face of the case 50a can be provided to be a lower face.

According to the third embodiment, it is possible to obtain the following advantages in addition to the same advantages as those of the (1) and (2) described in the first embodiment.

(11) In the third embodiment, the first connecting portion 50h and the second connecting portion 50j are formed on the bottom face of the case 50a, and the ink lead-out port 50i and the air introducing port 50k penetrate and are opened at the bottom face of the case 50a, respectively. Consequently, the ink cartridge 50 can be caused to cope with the case in which the air is to be introduced into or the ink is to be led out of the bottom face of the case 50a corresponding to a position in which the ink cartridge 50 is provided and a position of the air pump 33. Accordingly, it is possible to enhance the degree of freedom of the design of the printer body 11.

Each of the embodiments may be changed as follows.

While the four ink cartridges 45 to 48 are provided in each of the embodiments, the number of the ink cartridges mounted on the printer body 11 may be optional.

In each of the embodiments, the bottom face of the case and the lid in the ink cartridges 45 to 48 are provided in the printer body 11 in almost parallel with the right side plate 12a and the left side plate 12b in the frame 12. In addition, the ink cartridges 45 to 48 may be provided in any direction, for example, the bottom face of the case is provided to be a lower face.

In the embodiments, the films 45f1, 45f2 and 50e or the inner film 49e may be thermally welded so as to partition the case in a loose state as in the second embodiment. Thus, the films 45f1, 45f2 and 50e or the inner film 49e can be flexed to pressurize the ink even if the amount of the ink is very small. Moreover, the bottom or side faces of the ink chambers 45g, 49f and 50f may be curved so as to coincide with the shape of the flexed film. Thus, the ink can be prevented from remaining in the corner portions of the ink chambers 45g, 49f and 50f. Consequently, the lead-out property of the ink can be enhanced more greatly.

In the first, and third embodiments, the lids 45b, 45c and 50b may be constituted by a film as shown in the second embodiment, and furthermore, may be covered with a protecting lid as in the fourth embodiment, Thus, a step of assembling the ink cartridges 45 and 50 can be prevented from being complicated.

In the second embodiment, the first connecting portion 49j may be formed on the bottom faces of the cases as in the third embodiment. Thus, the ink lead-out port 49k or the air introducing port (not shown) can be opened at the bottom face. Consequently, it is possible to enhance the degree of freedom of the design of the printer body 11.

While the films 45f1, 45f2 are constituted by laminating polypropylene, gas barrier layer, nylon and the like in the above embodiments, the film may be formed with a two-layer structure in a case that a gas barrier layer is provided with a material inactive to environment. For example, a film having two-layer structure constituted by propylene as welding layer and EVOH resin (ethylene-vinyl alcohol copolymer) as gas barrier layer may be served as the flexible films of the invention.

While the liquid ejecting apparatus is used in the ink jet printer in each of the embodiments, it may be applied to a liquid ejecting apparatus for injecting a liquid other than an ink. For example, it is also possible to employ a liquid ejecting apparatus for injecting a liquid such as an electrode material or a coloring material to be used in the manufacture of a liquid crystal display, an EL display or an FED (face emitting display), a liquid ejecting apparatus for injecting a biological organic matter to be used in the manufacture of a biochip, and a sample injecting apparatus to be a precision pipette.

What is claimed is:

1. A liquid storage unit comprising:
a case;
a liquid storage part for storing a liquid in the case, with which a liquid port communicates;
at least one gas accommodation part for accommodating a gas in the case, with which a gas port communicates, wherein the liquid in the liquid storage part is led out through the liquid port by a pressure of a gas introduced from the gas port;
an inner case provided in the case having a pair of openings on opposite side faces thereof; and
a pair of flexible partitioning members sealing said pair of openings of the inner case respectively, thereby partitioning the liquid storage part therebetween and defining said at least one of the gas accommodation part in cooperation with the case.

2. The liquid storage unit according to claim 1, wherein the flexible partitioning member is provided with a flexible film, which is thermally welded to a welding portion at the opening of the inner case.

3. The liquid storage unit according to claim 2, wherein the flexible film has a laminate structure including at least a welding layer formed with a material weldable to the welding portion and a gas barrier layer.

4. The liquid storage unit according to claim 1, wherein the case in which the inner case is provided has openings at a pair of side faces thereof corresponding to the openings of the inner case, and lids are sealed on the openings of the case respectively.

5. A liquid storage unit comprising:
a case having an opening on a side face thereof;
a liquid storage part for storing a liquid in the case, with which a liquid port communicates;
at least one gas accommodation part for accommodating a gas in the case, with which a gas port communicates, wherein the liquid in the liquid storage part is led out through the liquid port by a pressure of a gas introduced from the gas port;
a first flexible partitioning member thermally welded to the case so as to define the liquid storage part in cooperation with the case;
a second flexible partitioning member sealing the opening of the case by thermal welding so as to define said at least one gas accommodation part in cooperation with the first partitioning member and the case.

6. The liquid storage unit according to claim 5, wherein a protecting lid covering the second flexible partitioning member sealing the opening is provided in the case.

7. A liquid ejecting apparatus comprising a liquid ejection head for discharging a liquid supplied from the liquid storage unit according to claim 1, and a carriage for being reciprocated with the liquid ejection head mounted thereon.

8. A liquid ejecting apparatus comprising a liquid ejection head for discharging a liquid supplied from the liquid storage unit according to claim 5, and a carriage for being reciprocated with the liquid ejection head mounted thereon.
